(19) United States
(12) Patent Application Publication
(10) Pub. No.: US 2010/0309699 A1
(43) Pub. Date: Dec. 9, 2010

(54) POWER FACTOR CORRECTION CIRCUIT

(75) Inventor: Yukihiro NISHIKAWA, Tokyo (JP)

Correspondence Address: RABIN & Berdo, PC, 1101 14TH STREET, NW, SUITE 500, WASHINGTON, DC, 20005, US

(73) Assignee: FUJI ELECTRIC SYTEMS CO., LTD, Tokyo (JP)

(21) Appl. No.: 12/788,352

(22) Filed: May 27, 2010

(30) Foreign Application Priority Data
Jun. 3, 2009 (JP) 2009-133886

(51) Int. Cl. H02M 7/06

(52) U.S. Cl. 363/126; 361/18

(57) ABSTRACT

A power factor correction circuit includes a filter capacitor interposed between AC input terminals, a first inductor interposed between the first end of the filter capacitor and an input of a first rectifying bridge circuit, and a second inductor interposed between the second end of the filter capacitor and another input of the first rectifying bridge circuit. The power factor correction circuit further includes a second rectifying bridge circuit including inputs connected to AC input terminals, and outputs connected to a smoothing capacitor. A control circuit controls switching devices in the first rectifying bridge circuit. The power factor correction circuit can facilitate preventing an overcurrent from flowing through diodes and parasitic diodes in the switching devices, using a simple configuration.

### CROSS-REFERENCE TO RELATED APPLICATIONS

This application claims priority under 35 U.S.C. §119 from JP PA 2009-133886, filed Jun. 3, 2009, the entirety of which is incorporated herein by reference.

### FIELD OF THE INVENTION

The present invention relates to a power factor correction circuit that controls the current flowing through AC input terminals by the ON-OFF operation of a switching device to be sinusoidal for obtaining a DC output.

### BACKGROUND

FIG. 17 is a circuit diagram of a conventional power factor correction circuit. Referring now to FIG. 17, the conventional power factor correction circuit conducts the full-wave-rectification of an AC voltage fed to AC input terminals 1a and 1b with rectifying bridge circuit 3 formed of diodes 3a through 3d. The conventional power factor correction circuit boosts the output voltage fed from rectifying bridge circuit 3 with a boost chopper circuit formed of inductor 4, MOSFET 6 working as a switching device, diode 8, and smoothing capacitor 10. Therefore, the DC voltage boosted by the boost chopper circuit described above is fed from DC output terminals 11a and 11b.

The ON-duty of MOSFET 6 in the boost chopper circuit is controlled so that the current flowing through AC input terminals 1a and 1b may be sinusoidal and so that the output from DC output terminals 11a and 11b may be constant. In FIG. 17, filter capacitor 2, parasitic diode 6a of MOSFET 6 and bypass diode 15 for protecting MOSFET 6 and diode 8 from the rush current caused at the start of the circuit or at a power fail recovery are shown.

In rectifying bridge circuit 3, a current flows through two diodes without exception. In the state in which the voltage at AC input terminal 1a is higher than the voltage at AC input terminal 1b, a current flows through diodes 3a and 3d. In the state in which the voltage at AC input terminal 1a is lower than the voltage at AC input terminal 1b, a current flows through diodes 3b and 3c.

Since the forward voltage drop caused when a current flows through any of diodes 3a through 3d is from 0.7 to 1 V, the total forward voltage drop caused when a current flows through diodes 3a and 3d or through diodes 3b and 3c is from 1.4 to 2 V. Therefore, as the capacity of the power supply to which the power factor correction circuit as described above is applied becomes larger, the losses caused in rectifying bridge circuit 3 become more pronounced, causing a lowering of conversion efficiency in the power factor correction circuit.

Japanese Unexamined Patent Application Publication No. 2002-51563 (hereafter, “Patent Document 1”) and Japanese Unexamined Patent Application Publication No. 2004-72846 (hereafter, “Patent Document 2”) propose power factor correction circuits that provide the MOSFETs and diodes in the boost chopper circuit with a rectifying bridge function, for reducing the losses in rectifying bridge circuit 3.

FIG. 18 is a circuit diagram showing another conventional power factor correction circuit having a circuit configuration similar to the circuit configuration described in the Patent Document 1. The conventional power factor correction circuit shown in FIG. 18 includes rectifying bridge circuit 12 including a series circuit of MOSFET 6 and diode 8 and a series circuit of MOSFET 7 and diode 9. The series circuits are connected in parallel to each other. The first input of rectifying bridge circuit 12 is connected to AC input terminal 1a via inductor 4 and the second input thereof to AC input terminal 1b. The first and second outputs of rectifying bridge circuit 12 are connected to DC output terminals 11a and 11b, respectively. Filter capacitor 2 is interposed between AC input terminals 1a and 1b. Smoothing capacitor 10 is interposed between DC output terminals 11a and 11b. Parasitic diode 7a of MOSFET 7 is shown in FIG. 18.

Now the operations of the circuit shown in FIG. 18 will be described below with reference to FIGS. 19A through 19D.

As MOSFET 6 is turned ON in the state in which the voltage at AC input terminal 1a is higher than the voltage at AC input terminal 1b, a current flows through the path described in FIG. 19A and an electric energy is stored in inductor 4. A current flows through the path described in FIG. 19A, as MOSFET 6 is turned OFF, and the electric energy stored in inductor 4 is released. On the current paths described in FIGS. 19A and 19B, parasitic diode 7a of MOSFET 7 is present.

As MOSFET 7 is turned ON in the state in which the voltage at AC input terminal 1a is lower than the voltage at AC input terminal 1b, a current flows through the path described in FIG. 19C and an electric energy is stored in inductor 4. A current flows through the path described in FIG. 19D, as MOSFET 7 is turned OFF, and the electric energy stored in inductor 4 is released. On the current paths described in FIGS. 19A and 19D, parasitic diode 6a of MOSFET 6 is present.

In the circuit as shown in FIG. 18, the AC input voltage becomes higher than the voltage across capacitor 10 (the output voltage) sometimes. If the voltage at AC input terminal 1a is higher than the voltage at AC input terminal 1b, when the AC input voltage is higher than the voltage across capacitor 10, a rush current will flow through the path described in FIG. 19B. If the voltage at AC input terminal 1a is lower than the voltage at AC input terminal 1b, when the AC input voltage is higher than the voltage across capacitor 10, a rush current will flow through the path described in FIG. 19D. The occurrences of the rush currents imply that an overcurrent flows through diodes 8 and 9 and the insides (the parasitic diodes) of MOSFETs 6 and 7.

When MOSFET 6 or MOSFET 7 is turned ON in the circuit as shown in FIG. 18, diode 8 or diode 9 recovers reversely. Therefore, it is necessary to employ a high-speed diode that exhibits a short recovery time for diodes 8 and 9.

Since the high-speed diodes and the parasitic diodes in the MOSFETs (e.g. parasitic diodes 6a and 7a in FIG. 18) exhibit a small current overload capacity, the high-speed diodes and the parasitic diodes may be broken down when the rush current is caused.

Patent Document 2 proposes a power factor correction circuit as shown in FIG. 20, provided with a means for preventing the diodes and MOSFETs described above from being broken down. The circuit shown in FIG. 20 includes diodes 3a and 3b and thyristors 14a and 14b added to the circuit shown in FIG. 18. Further, inductor 13 is connected in substitution for inductor 4 shown in FIG. 18 for reducing the circuit size.

In the power factor correction circuit shown in FIG. 20, diode 3a is interposed between AC input terminal 1a and DC output terminal 11a, diode 3b between AC input terminal 1b and DC output terminal 11a, thyristor 14a between AC input terminal 1a and DC output terminal 11b, and thyristor 14b between AC input terminal 1b and DC output terminal 11b.

Inductor 13 includes inductors 13a and 13b coupled magnetically to each other. Inductor 13a is interposed between AC input terminal 1a and the first input of rectifying bridge circuit 12. Inductor 13b is interposed between AC input terminal 1b and the second input of rectifying bridge circuit 12.

When a state in which an overcurrent flows through the path described in FIG. 19B is caused in the circuit shown in FIG. 20, thyristor 14b is turned ON before the overcurrent flows. By the turning ON of thyristor 14b, the overcurrent is made to flow through diode 3a and thyristor 14b, preventing diode 8 and MOSFET 7 from being broken down.

When a state in which an overcurrent flows through the path described in FIG. 19D is caused in the circuit shown in FIG. 20, thyristor 14a is turned ON before the overcurrent flows. By the turning ON of thyristor 14a, the overcurrent is made to flow through diode 3b and thyristor 14a, preventing diode 9 and MOSFET 6 from being broken down.

However, it is necessary to provide the circuit shown in FIG. 20 separately with a power fail detector circuit (a circuit that detects the conditions under which an overcurrent is caused) that judges whether it is necessary to turn ON thyristor 14a or 14b or not, and with a driver circuit that drives thyristor 14a and 14b. Therefore, the circuit configuration is complicated and the manufacturing costs of the circuit soar. If the power fail time is shorter than the time necessary for detecting the power fail, it will be impossible to accomplish the overcurrent bypass, since the power fail is not detected.

In view of the foregoing, it would be desirable to obviate the problems described above. It would be also desirable to provide a power factor correction circuit that facilitates preventing an overcurrent from flowing through the high-speed diodes and the parasitic diodes in the MOSFETs with a simple circuit configuration, and that improves conversion efficiency and reliability.

### SUMMARY OF THE INVENTION

According to an aspect of the invention, there is provided a power factor correction circuit including a filter capacitor interposed between AC input terminals, and a first rectifying bridge circuit including a plurality of series circuits connected parallel to each other, each of the series circuits including a switching device and a rectifying device connected in series to each other. According to the aspect, the power correction circuit further includes a smoothing capacitor connected in parallel to the output of the first rectifying bridge circuit, a first inductor interposed between the first end of the filter capacitor and the first input of the first rectifying bridge circuit, and a second inductor interposed between the second end of the filter capacitor and the second input of the first rectifying bridge circuit. According to the aspect, the power correction circuit still further includes a second rectifying bridge circuit including diodes connected to form a bridge, the second rectifying bridge circuit including an input connected to any of the AC input terminals and an output connected to the smoothing capacitor, and a control circuit controlling the switching devices in the first rectifying bridge circuit.

Advantageously, the first inductor and the second inductor are coupled magnetically to each other such that the directions of magnetic fluxes generated by the currents flowing through the first inductor and the second inductor are opposite to each other.

Advantageously, the power factor correction circuit further includes another inductor or other inductors connected in series to either one or both of the first inductor and the second inductor.

Advantageously, the first inductor and the second inductor are replaced by a leakage transformer including windings corresponding to the first inductor and the second inductor.

Advantageously, the leakage transformer includes a core having a magnetic path leg positioned between the windings.

Advantageously, the switching device in the first bridge circuit is a MOSFET.

Advantageously, the control circuit includes an overcurrent detector and the control circuit suppresses an overcurrent, when the overcurrent is detected.

According to another aspect of the invention, there is provided a power factor correction circuit including N groups of the power factor correction circuit described herein and connected in parallel to each other, wherein N=1, 2, 3, . . . .

Advantageously, the ON-timings of the switching devices in the N groups of the power factor correction circuits are displaced by T/N, wherein T is the ON-period of the switching devices.

Stated in other terms, embodiments of the invention relate to a circuit that can comprise a first bridge circuit including at least a switching device and a rectifying device connected in series, and a second bridge circuit including a plurality of diodes connected in series. The circuit can further comprise a first inductor connected between a first input of the first bridge circuit and a first input of the second bridge circuit, and a second inductor connected between a second input of the first bridge circuit and a second input of the second bridge circuit.

The circuit can still further comprise a filter capacitor for connection to an AC input, wherein a first terminal of the filter capacitor is connected to the first input of the second bridge circuit, and a second terminal of the filter capacitor is connected to the second input of the second bridge circuit. The circuit can still further comprise a smoothing capacitor connected in parallel to an output of the first bridge circuit. Additionally, the circuit can yet further comprise an overcurrent detector, and a control circuit to suppress an overcurrent detected by the overcurrent detector.

Embodiments of the invention further relate to a circuit that can comprise a first bridge circuit including at least a switching device and a rectifying device connected in series, and a second bridge circuit including a plurality of diodes connected in series. The circuit can further comprise an inductor including first and second windings wound around a core so as to be magnetically coupled. A first terminal of the first winding can be connected to a first input of the second bridge circuit, and a second terminal of the first winding can be connected to a first input of the first bridge circuit. A first terminal of the second winding can be connected to a second input of the second bridge circuit, and a second terminal of the second winding can be connected to a second input of the first bridge circuit. A direction of a magnetic flux generated by a current flowing from the first terminal of the first winding to the second terminal of the first winding can be opposite to a direction of a magnetic flux generated by a current flowing from the second terminal of the second winding to the first terminal of the second winding.

The power factor correction circuit according to the invention exhibits the following effects.

(1) The power loss caused in the diode in the second rectifying bridge circuit is reduced and the overcurrent caused at the start of operation of the circuit or at a power fail recovery is made not to flow through the diodes in the first rectifying bridge circuit (the high-speed diodes), nor through the parasitic diodes of the switching devices (the MOSFETs).

(2) The changing rate of the current flowing through the inductor is reduced and the power losses caused in the switching devices and the rectifying devices are reduced.

(3) The power losses caused in the inductors, switching devices and rectifying devices are dispersed. The downsizing of a heat sink for cooling the semiconductor devices and the downsizing of inductors and such component parts are facilitated.

### BRIEF DESCRIPTION OF THE DRAWINGS

FIG. 1 is a circuit diagram showing a power factor correction circuit according to a first embodiment of the invention.

FIG. 2 is a circuit diagram describing the current path in the steady-state operations of the power factor correction circuit shown in FIG. 1.

FIG. 3 is a circuit diagram describing the other current path in the steady-state operations of the power factor correction circuit shown in FIG. 1.

FIG. 4 is a circuit diagram describing a current path in the non-steady-state operations of the power factor correction circuit shown in FIG. 1.

FIG. 5 is a circuit diagram showing a power factor correction circuit according to a second embodiment of the invention.

FIG. 6 is a drawing showing the detailed structure of the inductor shown in FIG. 5.

FIG. 7 is a circuit diagram showing the current path in the steady-state operations in the power factor correction circuit according to the second embodiment.

FIG. 8 is an equivalent circuit diagram of the power factor correction circuit according to the second embodiment that is operating as described in FIG. 7.

FIG. 9 is a circuit diagram showing the other current path in the steady-state operations in the power factor correction circuit according to the second embodiment.

FIG. 10 is a circuit diagram showing the current path in the non-steady-state operations in the power factor correction circuit according to the second embodiment.

FIG. 11 is a schematic describing the structure of a leakage transformer.

FIG. 12 is a schematic describing the structure of another leakage transformer.

FIG. 13 is a circuit diagram showing a power factor correction circuit according to a third embodiment of the invention.

FIG. 14 is a wave chart describing an example of the control mode for the MOSFET according to the third embodiment of the invention.

FIG. 15 is a block circuit diagram showing an example of the control circuit that controls the ON and OFF of MOSFETs.

FIG. 16 is a block circuit diagram showing another example of the control circuit that controls the ON and OFF of MOSFETs.

FIG. 17 is a circuit diagram of a conventional power factor correction circuit.

FIG. 18 is a circuit diagram of another conventional power factor correction circuit.

FIG. 19A is a first circuit diagram for describing the operations of the conventional power factor correction circuit shown in FIG. 18.

FIG. 19B is a second circuit diagram for describing the operations of the conventional power factor correction circuit shown in FIG. 18.

FIG. 19C is a third circuit diagram for describing the operations of the conventional power factor correction circuit shown in FIG. 18.

FIG. 19D is a fourth circuit diagram for describing the operations of the conventional power factor correction circuit shown in FIG. 18.

FIG. 20 is a circuit diagram of still another conventional power factor correction circuit.

### DETAILED DESCRIPTION OF THE INVENTION

The invention will now be described in detail hereinafter with reference to the accompanying drawings.

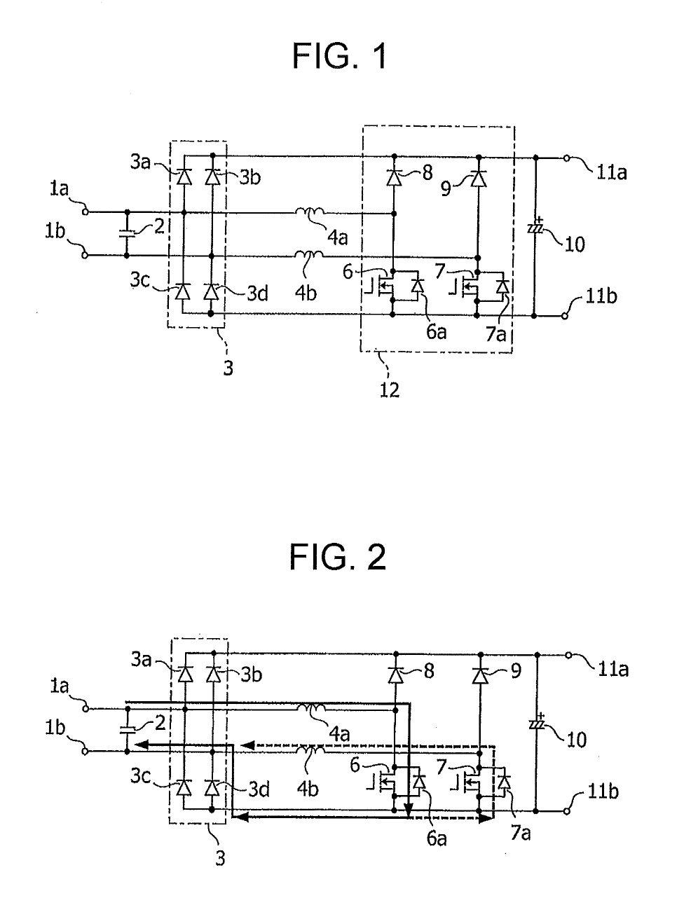

FIG. 1 is a circuit diagram showing a power factor correction circuit according to a first embodiment of the invention. In FIG. 1, the same reference numerals as used in FIG. 18 are used to designate the same constituent elements and their duplicated description are omitted for the sake of simplicity.

The power factor correction circuit according to the first embodiment is different from the conventional power factor correction circuit shown in FIG. 18 in that rectifying bridge circuit 3 is interposed between AC input terminals 1a and 1b and rectifying bridge circuit 12. The power factor correction circuit shown in FIG. 1 is different from the conventional power factor correction circuit shown in FIG. 18 also in that inductor 4a is interposed between AC input terminal 1a and the first input of rectifying bridge circuit 12, and inductor 4b is interposed between AC input terminal 1b and the second input of rectifying bridge circuit 12. In contrast, in the conventional power factor correction circuit shown in FIG. 18, only inductor 4 corresponding to inductor 4a is present.

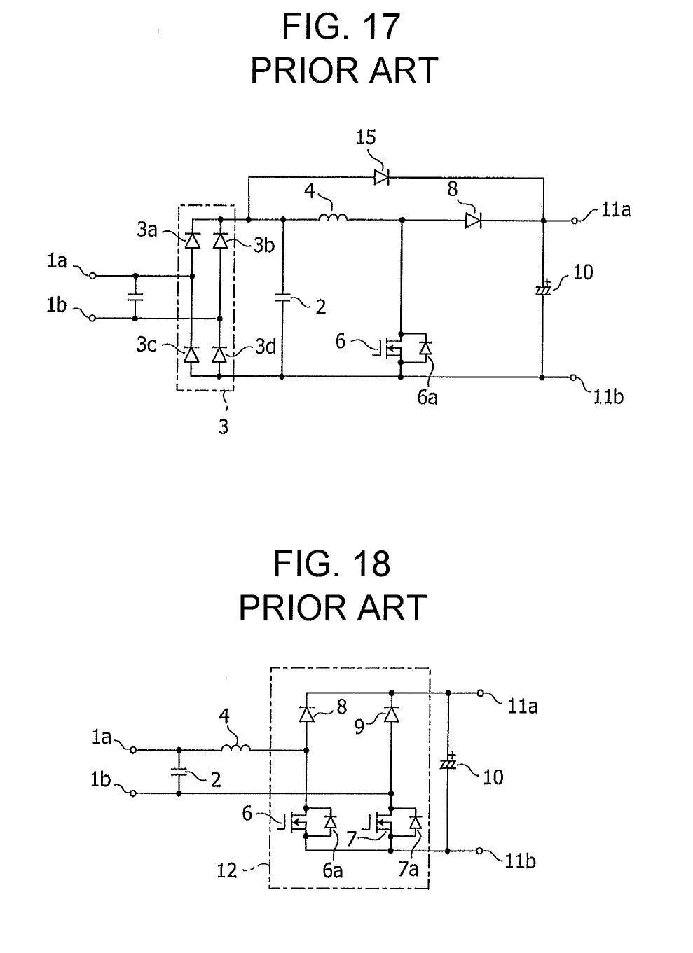

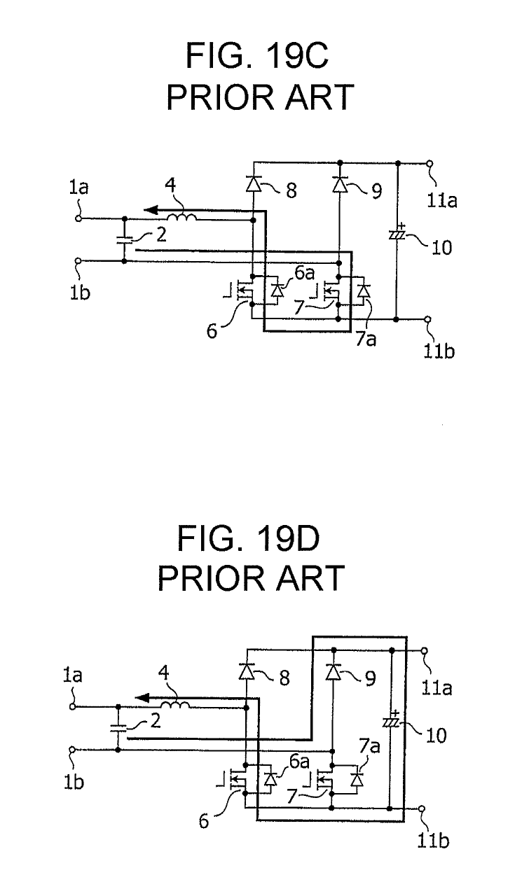

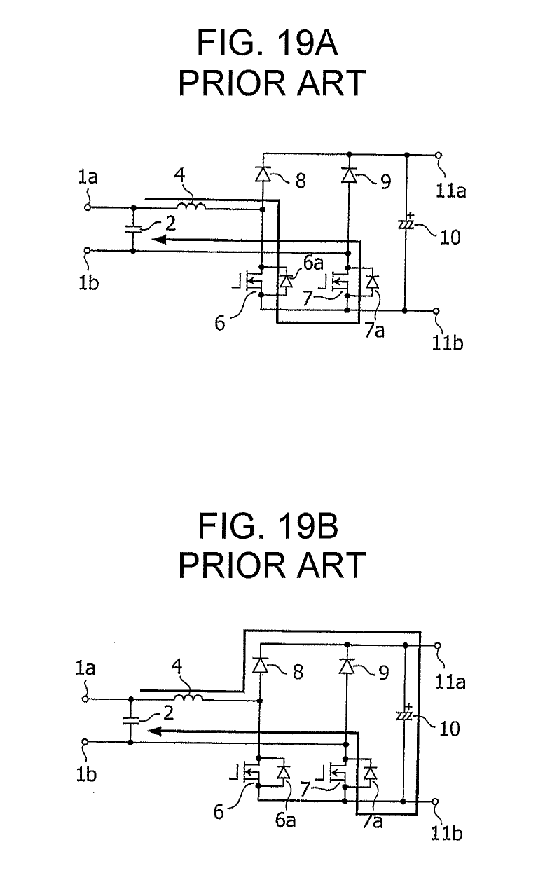

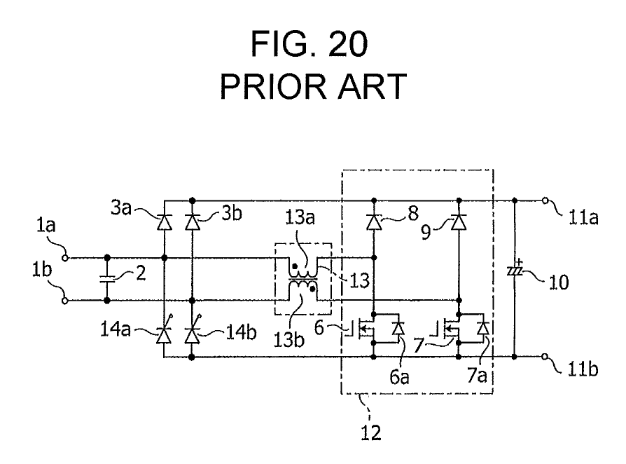

Rectifying bridge circuit 3 includes a bridge connection of diodes 3a through 3d as described earlier with reference to FIG. 17. Rectifying bridge circuit 12 includes a series circuit of MOSFET 6 and diode 8 and a series circuit of MOSFET 7 and diode 9. The series circuits are connected in parallel to each other as described earlier with reference to FIG. 18. The inputs of rectifying bridge circuit 3 are connected to AC input terminals 1a and 1b and the output thereof to DC output terminals 11a and 11b.

Next, the operations of the power factor correction circuit according to the first embodiment will be described below with reference to FIGS. 2 through 4.

First, the steady-state operations will be described. The steady-state operations include a first steady-state operation conducted when the voltage at AC input terminal 1a is higher than the voltage at AC input terminal 1b, and a second steady-state operation conducted when the voltage at AC input terminal 1a is lower than the voltage at AC input terminal 1b. Since the second steady-state operation can be estimated easily from the first steady-state operation, only the first steady-state operation will be described below.

As MOSFET 6 is turned ON, a current flows through the path described in FIG. 2, and an electric energy is stored in inductor 4a. Since the voltage applied across inductor 4b is the voltage difference between the forward voltage drop across diode 3d and the forward voltage drop across parasitic diode 7a of MOSFET 7, the current that flows through inductor 4b (cf. the broken lines) is small. Therefore, most of the currents flow through the path described by the solid lines in FIG. 2.

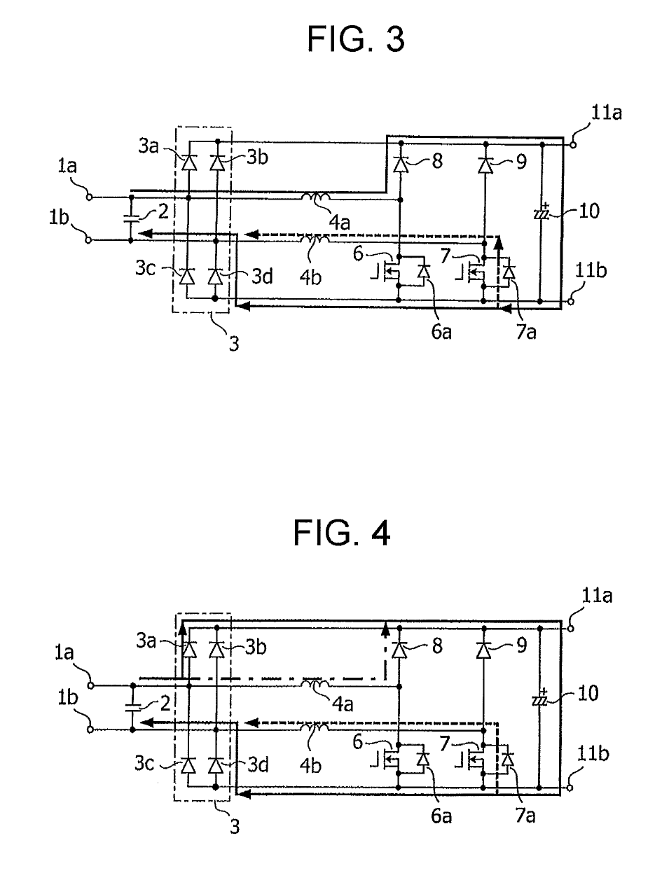

As MOSFET 6 is turned OFF, the electric energy stored in capacitor 4a is released through the path described in FIG. 3. Since the voltage applied across inductor 4b is the voltage difference between the forward voltage drop across diode 3d and the forward voltage drop across parasitic diode 7a of MOSFET 7, the current that flows through inductor 4b (cf. the broken lines) is small. Therefore, most of the currents flow through the path described by the solid lines in FIG. 3.

Next, the non-steady-state operations, conducted at the start of operation of the circuit or at a power fail recovery, will be described. The non-steady-state operations include a first non-steady-state operation conducted when the voltage at AC input terminal 1a is higher than the voltage at AC input terminal 1b and a second non-steady-state operation conducted when the voltage at AC input terminal 1a is lower than the voltage at AC input terminal 1b. Since the second non-steady-state operation can be understood easily from the first non-steady-state operation, only the first non-steady-state operation will be described below.

When the voltage across the AC input terminals is higher than the voltage across smoothing capacitor 10, a current (a high rush current) that charges capacitor 10 flows through the path described in FIG. 4. Since the voltage applied across inductor 4a is the voltage difference between the forward voltage drop across diode 3a and the forward voltage drop across diode 8, the current that flows through inductor 4a (cf. the single-dotted chain lines) is small. Since the voltage applied across inductor 4b is the voltage difference between the forward voltage drop across diode 3d and the forward voltage drop across parasitic diode 7a of MOSFET 7, the current that flows through inductor 4b (cf. the broken lines) is small.

As the above description clearly indicates, the power factor correction circuit according to the first embodiment makes the rush current (the charging current of capacitor 10) caused in the non-steady-state operations flow through the path described by the solid lines. Since any overcurrent does not flow through constituent elements 6 through 9 of rectifying bridge circuit 12, constituent elements 6 through 9 are prevented from being broken by the overcurrent. The charging current of capacitor 10 flows through the diodes in rectifying bridge circuit 3. Therefore, it is desirable to configure rectifying bridge circuit 3 with low-speed diodes for general rectification use that exhibit a high allowable peak current.

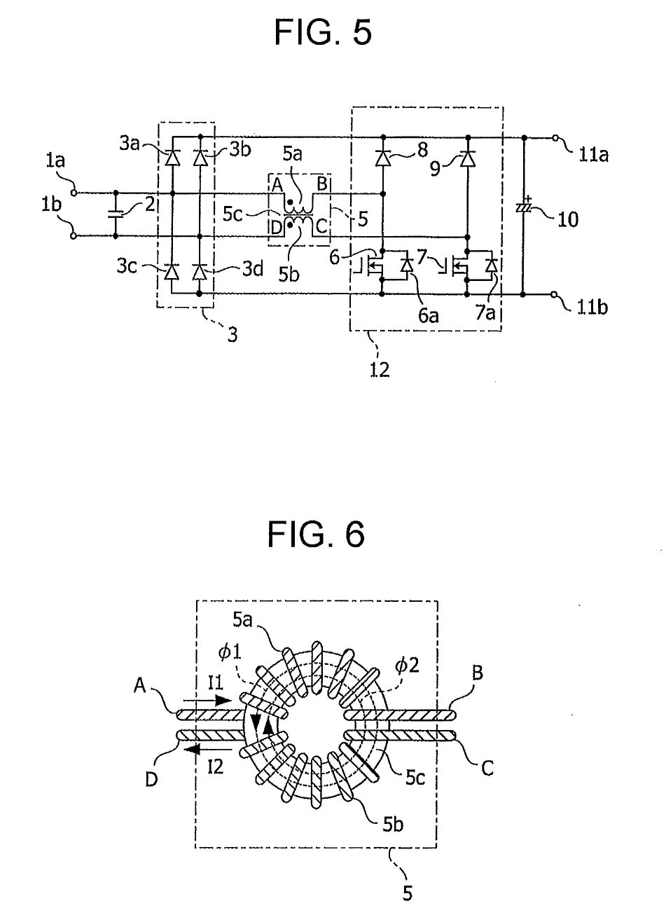

FIG. 5 is a circuit diagram showing a power factor correction circuit according to a second embodiment of the invention.

The power factor correction circuit according to the second embodiment is different from the power factor correction circuit according to the first embodiment in that inductors 4a and 4b are replaced by inductor 5 in FIG. 5.

FIG. 6 is a drawing showing the detailed structure of inductor 5 shown in FIG. 5.

As shown in FIG. 6, inductor 5 includes windings 5a and 5b wound around core 5c to be coupled magnetically to each other. Windings 5a and 5b are wound such that the direction of the magnetic flux ψ1 generated by the current I1 that flows from terminal A to terminal B is opposite to the direction of the magnetic flux ψ2 generated by the current I2 that flows from terminal C to terminal D.

Next, the operations of the power factor correction circuit according to the second embodiment will be described below.

First, steady-state operations will be described. The steady-state operations include a first steady-state operation conducted when the voltage at AC input terminal 1a is higher than the voltage at AC input terminal 1b and a second steady-state operation conducted when the voltage at AC input terminal 1a is lower than the voltage at AC input terminal 1b. Since the second steady-state operation can be understood easily from the first steady-state operation, only the first steady-state operation will be described below.

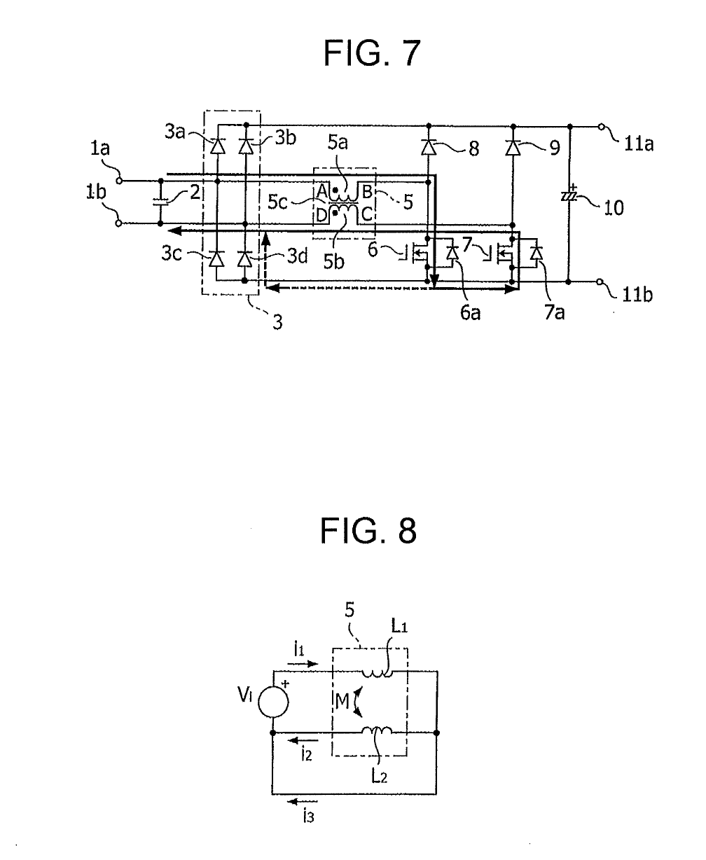

A current flows through the path described in FIG. 7, as MOSFET 6 is turned ON, and an electric energy is stored in the leakage inductance (not shown) of inductor 5. Since the voltage across winding 5b is generated in the direction that blocks the current flowing through diode 3d, the current that flows through diode 3d (cf. the broken lines) is small. Therefore, most of the currents flow through the path described by the solid lines.

The operations described above will be described more in detail below. The equivalent circuit of the circuit described above in the operation mode described in FIG. 7 is shown in FIG. 8. In FIG. 8, the self-inductance L₁ of winding 5a, the self-inductance L₂ of winding 5b, the mutual inductance M of the self inductance L₁ and the self inductance L₂, the instantaneous value Vi of the AC input voltage, the current i₁ that flows through winding 5a, the current i₂ that flows through winding 5b, and the current i₃ that flows through diode 3d are shown.

The relations described by the following differential equations hold from FIG. 8.

$$\begin{matrix}{L}_{1} \frac{d {i}_{1}}{d t} - M \frac{d {i}_{2}}{d t} = {V}_{i} & ( 1 ) \\ {L}_{2} \frac{d {i}_{2}}{d t} - M \frac{d {i}_{1}}{d t} = 0 & ( 2 ) \\ {i}_{3} = {i}_{1} - {i}_{2} & ( 3 )\end{matrix}$$

The mutual inductance M in the equation (2) is expressed in the following way using the coupling coefficient k.

M=k\sqrt{L₁L₂}

By putting L₁ to be equal to L₂ and by rewriting the equation (2), the following equation (4) is obtained.

$$\frac{d {i}_{2}}{d t} = k \frac{d {i}_{1}}{d t} \qquad ( 4 )$$

From the equation (4), the relation expressed by the following equation (5) is obtained.

i₂=k·i₁ (5)

From the equation (3), the relation expressed by the following equation (6) is obtained.

i₃=(1-k)·i₁ (6)

As the equation (6) clearly indicates, the current i₃ that flows through diode 3d can be reduced by setting the coupling coefficient k at an appropriate value.

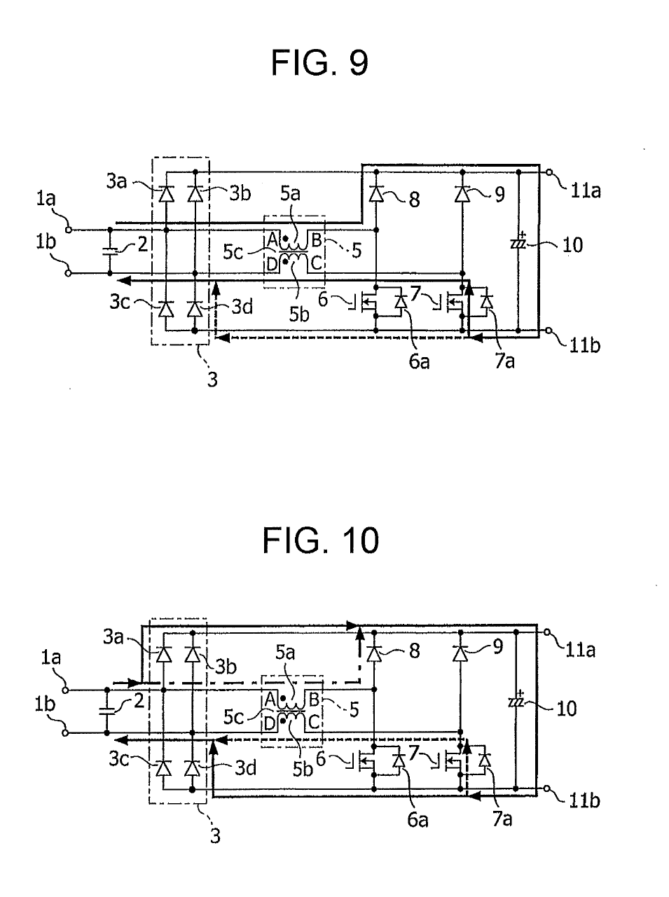

As MOSFET 6 is turned OFF, a current flows through the path described in FIG. 9 and the electric energy stored in the leakage inductance of inductor 5 is released. Since the voltage across winding 5b is generated in the direction that blocks the current flowing through diode 3d, the current that flows through diode 3d (cf. the broken lines) is small. Therefore, most of the currents flow through the path described by the solid lines.

The relation described by the foregoing equation (6) holds also in the operation mode described with reference to FIG. 9. Therefore, the current i₃ that flows through diode 3d can be reduced by setting the coupling coefficient k at an appropriate value.

Next, the non-steady-state operations, conducted at the start of operation of the circuit or at a power fail recovery, will be described. The non-steady-state operations include a first non-steady-state operation conducted when the voltage at AC input terminal 1a is higher than the voltage at AC input terminal 1b, and a second non-steady-state operation conducted when the voltage at AC input terminal 1a is lower than the voltage at AC input terminal 1b. Since the second non-steady-state operation can be understood easily from the first non-steady-state operation, only the first non-steady-state operation will be described below.

When the voltage across the AC input terminals is higher than the voltage across smoothing capacitor 10, a current (a high rush current) that charges capacitor 10 flows through the path described in FIG. 10. Since the voltage applied across winding 5a of inductor 5 is the voltage difference between the forward voltage drop across diode 3a and the forward voltage drop across diode 8, the current that flows through winding 5a (cf. the single-dotted chain lines) is small. Since the voltage applied across winding 5b of inductor 5 is the voltage difference between the forward voltage drop across diode 3d and the forward voltage drop across parasitic diode 7a of MOSFET 7, the current that flows through winding 5b (cf. the broken lines) is small.

As the above description clearly indicates, the power factor correction circuit according to the second embodiment makes most of the rush current (the charging current of capacitor 10) caused in the unsteady-state operations flow through the path described by the solid lines. Since any overcurrent does not flow through constituent elements 6 through 9 of rectifying bridge circuit 12, constituent elements 6 through 9 are prevented from being broken by the overcurrent.

Since the power factor correction circuit that employs inductor 5 facilitates reducing the number of the inductors as compared with the power factor correction circuit shown in FIG. 1, the power factor correction circuit according to the second embodiment is more advantageous to reduce the size and the manufacturing costs of the power factor correction circuit.

The charging current of capacitor 10 flows through the diodes in rectifying bridge circuit 3. Therefore, it is desirable to configure rectifying bridge circuit 3 with low-speed diodes for general rectification use that exhibit a high allowable peak current. The current that flows through rectifying bridge circuit 3 in the steady state operations is small. The charging current that charges capacitor 10 (the rush current) at the start of operation of the circuit or at a power fail recovery flows through rectifying bridge circuit 3 transiently for a short time. If one considers these facts, the rated current of rectifying bridge circuit 3 may be set to be small with no problem.

When the leakage inductance of inductor 5 is small, the changing rate of the current that flows through inductor 5 is large. In this case, the turnoff currents of MOSFETs 6 and 7 become high, increasing the turnoff losses and the conduction losses. When there is a concern that the turnoff losses and the conduction losses will be too large, another inductor or other inductors are connected to either one or both of windings 5a and 5b in series to lower the changing rate of the current that flows through inductor 5.

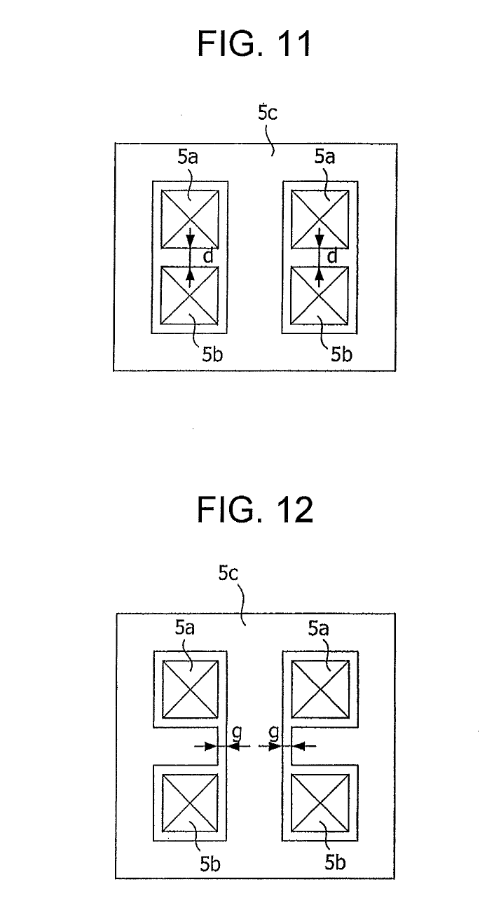

For obtaining much larger leakage inductance, inductor 5 may be provided with the leakage transformer structures as shown in FIGS. 11 and 12.

It is possible for the leakage transformer having the structure shown in FIG. 11 to increase the leakage inductance by adjusting the spacing d between windings 5a and 5b. It is possible for the leakage transformer having the structure shown in FIG. 12 to increase the leakage inductance by providing core 5c with a magnetic path leg positioned between windings 5a and 5b and by adjusting the gap length g formed by the magnetic path leg.

If inductor 5 is provided with any of the structures described above to obtain large leakage inductance, it will be possible to lower the changing rate of the current flowing through the inductor 5 without connecting another inductor or other inductors to either one or both of windings 5a and 5b in series.

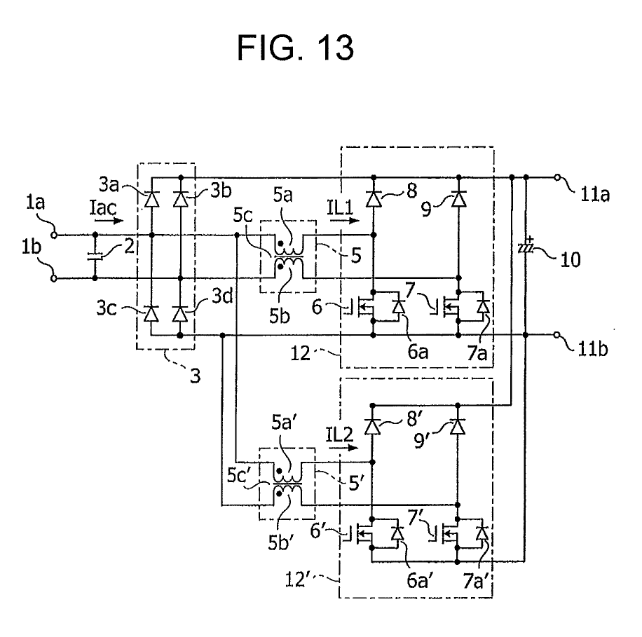

FIG. 13 is a circuit diagram showing a power factor correction circuit according to a third embodiment of the invention. The power factor correction circuit according to the third embodiment includes two groups of the circuit shown in FIG. 5 and connected in parallel to each other. The constituent elements in the added group of the circuit are marked with a prime “‘ ” in FIG. 13.

The power factor correction circuit according to the third embodiment facilitates reducing the electric power transmitted through one group of the circuit as compared with the circuit shown in FIG. 5. Therefore, the losses caused by inductors 5, 5′, MOSFETs 6, 6′, 7, 7′, and diodes 8, 8′, 9, 9′ are dispersed, and, as a result, the downsizing of the heat sink for cooling the semiconductor devices (MOSFETs 6, 6′, 7, 7′, etc.) and the downsizing of inductors 5 and 5′ are facilitated.

The circuit, a plurality of which is connected in parallel, is not always limited to the circuit shown in FIG. 5. The circuit, a plurality of which is to be connected in parallel, may be the circuit shown in FIG. 1 with no problem. The number of groups connected in parallel is not always limited to 2. Three or more groups of the circuit may be connected in parallel with no problem. In the power factor correction circuit shown in FIG. 13, rectifying bridge circuit 3 and smoothing capacitor 10 are used commonly for the circuit groups. Alternatively, each of the circuit groups may be provided with rectifying bridge circuit 3 and/or smoothing capacitor 10 individually.

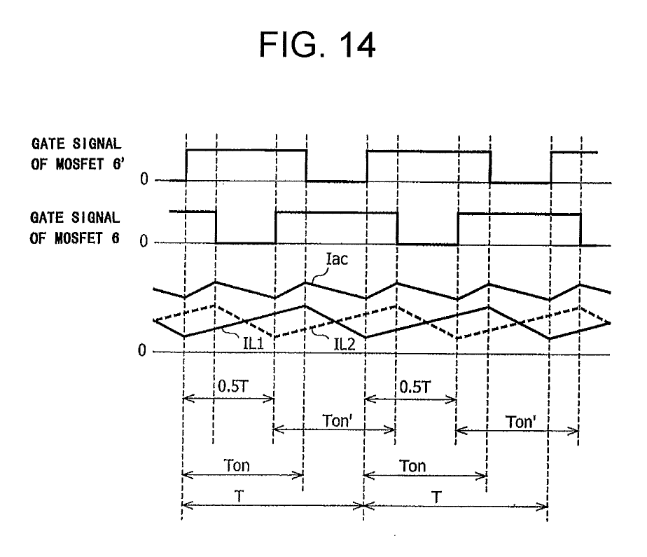

The gate signals described in FIG. 14 are fed to MOSFETs 6 and 6′, respectively. The gate signals of MOSFETs 6 and 6′ are generated for the period T and the timings thereof are displaced by 0.5 T from each other.

If MOSFETs 6 and 6′ are controlled by the gate signals as described above, MOSFETs 6 and 6′ are ON for the periods Ton and Ton′, respectively. Therefore, the ripple of the synthesized current Iac of the currents IL1 and IL2 flowing through inductors 5 and 5′ is minimized and the size of filter capacitor 2 and the size of the line filters (not-shown) connected to AC input terminals 1a and 1b are reduced. MOSFETs 7 and 7′ are controlled in the same manner as MOSFETs 6 and 6′.

If the ON-timings of the switching devices (the MOSFETs) in the adjacent groups are displaced from each other by T/N, in which N (N=2, 3, 4, . . . ) is the number of the power factor correction circuit groups connected in parallel, the effects described above (the effect of reducing the electric power transmitted through each circuit group and the effect of reducing the ripple of the synthesized current) are enhanced more as N is larger.

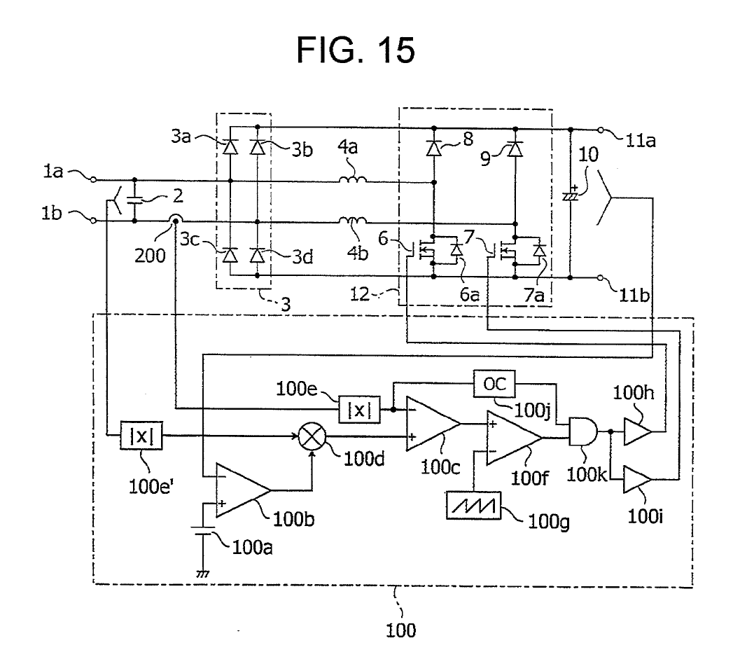

Although not illustrated in FIGS. 1 and 5, MOSFETs 6 and 7 in rectifying bridge circuit 12 in the power factor correction circuits shown in these drawings are controlled by the control circuit as shown in FIG. 15. Control circuit 100 shown in FIG. 15 is applied to the circuit shown in FIG. 1. Control circuit 100 shown in FIG. 15 is applicable also to the circuit shown in FIG. 5.

Control circuit 100 includes reference voltage source 100a, voltage error amplifier 100b, current error amplifier 100c, multiplier 100d, absolute value circuits 100e and 100e′, PWM comparator 100f, PWM carrier signal generator circuit 100g, and current detector 200.

Voltage error amplifier 100b amplifies the difference between a feedback signal corresponding to the output voltage (the voltage across smoothing capacitor 10) and a reference voltage fed from reference voltage source 100a. Voltage error amplifier 100b feeds a first error signal corresponding to the amplified difference. The feedback signal includes the detected but not modified output voltage, the divided value of the detected output voltage, and the detected output voltage, the level of which has been shifted.

Multiplier 100d multiplies the first error signal and the absolute value of the signal corresponding to the input voltage (the voltage across filter capacitor 2) and feeds the result of the multiplication to current error amplifier 100c as a reference current value. The signal corresponding to the input voltage includes the detected but not modified input voltage, the divided value of the input voltage, and input voltage, the level of which has been shifted.

Current error amplifier 100c amplifies the difference between the multiplication result described above and the absolute value of a signal corresponding to the current (the output current) detected by current detector 200 and feeds a second error signal corresponding to the amplified difference.

PWM comparator 100f compares the second error signal and a carrier signal such as a triangular wave signal and a saw-tooth wave signal fed from PWM carrier signal generator circuit 100g and feeds a PWM signal having a duty ratio corresponding to the magnitude of the second error signal.

Overcurrent detector circuit 100j feeds an overcurrent detection signal at a low level (hereinafter referred to as an “L-level”), when the absolute value of the output current detected by current detector 200 exceeds a predetermined value to the higher side.

AND circuit 100k calculates the logic AND of the PWM signal and the output signal from overcurrent detector circuit 100j and feeds the result of the AND calculation to the gates of MOSFETs 6 and 7 via gate drivers 100h and 100i. Therefore, MOSFETs 6 and 7 are turned ON and OFF simultaneously by the same gate signal. As overcurrent detector circuit 100j detects an overcurrent, both MOSFET 6 and MOSFET 7 are turned OFF.

Control circuit 100 facilitates controlling the ON and OFF of MOSFETs 6 and 7 based on the input voltage (the voltage across filter capacitor 2), the output voltage (the voltage across smoothing capacitor 10), and the output current such that the current flowing through AC input terminals 1a and 1b is shaped with a sinusoidal wave and such that the output from DC output terminals 11a and 11b is constant (equal to a reference voltage).

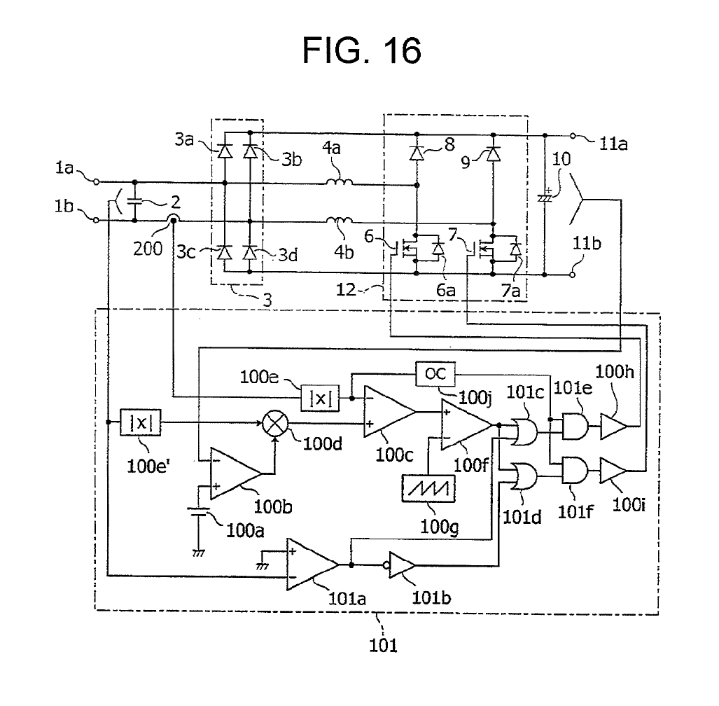

Control circuit 101 shown in FIG. 16 may be employed in substitution for control circuit 100. Control circuit 101 is different from control circuit 100 in that control circuit 101 includes comparator 101a, NOT circuit 101b, OR circuits 101c and 101d, and AND circuits 101e and 101f.

Comparator 101a determines the polarity of the input voltage (the voltage across filter capacitor 2) and feeds an L-level signal, when the voltage at the input terminal 1a is positive, or a high level (hereinafter referred to as an “H-level”) signal, when the voltage at the input terminal 1b is positive.

OR circuit 101c calculates the logic OR of the PWM signal fed from PWM comparator 100f and the output signal fed from comparator 101a. AND circuit 101e calculates the logic AND of the output signal from OR circuit 101c and the output signal from overcurrent detector circuit 100j and feeds the result of the AND calculation to the gate of MOSFET 6 via gate driver 100h.

OR circuit 101d calculates the logic OR of the PWM signal and the output signal from NOT circuit 101b connected to the output of comparator 101a. AND circuit 101f calculates the logic AND of the output signal from OR circuit 101d and the output signal from overcurrent detector circuit 100j and feeds the result of the AND calculation to the gate of MOSFET 7 via gate driver 100i.

Control circuit 101 controls MOSFETs 6 and 7 in the different manner as described below depending on the polarity of the input voltage (the voltage across filter capacitor 2).

When the voltage of input terminal 1a is positive:

Comparator 101a feeds an L-level signal. Therefore, OR circuit 101c feeds the PWM signal described above and OR circuit 101d sets the output thereof at the H-level. As a result, if overcurrent detector circuit 100j has not detected any overcurrent, the ON and OFF of MOSFET 6 will be controlled based on the PWM signal described above and MOSFET 7 will maintain the ON-state thereof.

When the voltage of input terminal 1b is positive:

Comparator 101a feeds an H-level signal. Therefore, OR circuit 101d feeds the PWM signal described above and OR circuit 101c sets the output thereof at the H-level. As a result, if overcurrent detector circuit 101j has not detected any overcurrent, MOSFET 6 will maintain the ON-state thereof and the ON and OFF of MOSFET 7 will be controlled based on the PWM signal described above.

If overcurrent detector circuit 100j has detected an overcurrent, MOSFETs 6 and 7 are both turned OFF in the same manner as in the foregoing control circuit 100.

The control circuit that generates the gate signals as described in FIG. 14 may be provided with the structure shown in FIG. 15 or 16. Note that it is necessary for the control circuit described above to be provided additionally with a delay element to displace the ON-timings of MOSFETs 6 and 6′ (MOSFETs 7 and 7′) by T/N.

Although the invention has been described in connection with the embodiments thereof, changes and modifications are obvious to the persons skilled in the art without departing from the true spirit of the invention.

For example, the power factor correction circuits according to the invention have been described in connection with a single-phase AC input voltage, the power factor correction circuit according to the invention may be configured for a three-phase AC input voltage. In the modification, rectifying bridge circuits 3 and 12 and inductors 4a, 4b, and 5 are replaced by the respective alternatives having the respective structures suitable for a three-phase AC input voltage.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

What is claimed is:

1. A power factor correction circuit comprising:
a filter capacitor interposed between AC input terminals;
a first rectifying bridge circuit comprising a plurality of series circuits connected parallel to each other, each of the series circuits comprising a switching device and a rectifying device connected in series to each other;
a smoothing capacitor connected in parallel to an output of the first rectifying bridge circuit;
a first inductor interposed between a first end of the filter capacitor and a first input of the first rectifying bridge circuit;
a second inductor interposed between a second end of the filter capacitor and a second input of the first rectifying bridge circuit;
a second rectifying bridge circuit comprising diodes connected to form a bridge, the second rectifying bridge circuit comprising an input connected to any of the AC input terminals and an output connected to the smoothing capacitor; and
a control circuit controlling the switching devices in the first rectifying bridge circuit.

2. The power factor correction circuit according to claim 1, wherein the first inductor and the second inductor are coupled magnetically to each other such that directions of magnetic fluxes generated by currents flowing through the first inductor and the second inductor are opposite to each other.

3. The power factor correction circuit according to claim 2, further comprising another inductor or other inductors connected in series to either one or both of the first inductor and the second inductor.

4. The power factor correction circuit according to claim 2, wherein the first inductor and the second inductor are replaced by a leakage transformer comprising windings corresponding to the first inductor and the second inductor.

5. The power factor correction circuit according to claim 4, wherein the leakage transformer comprises a core comprising a magnetic path leg positioned between the windings.

6. The power factor correction circuit according to claim 1, wherein the switching device in the first bridge circuit comprises a MOSFET.

7. The power factor correction circuit according to claim 1, wherein the control circuit comprises an overcurrent detector and the control circuit suppresses an overcurrent when the overcurrent is detected.

8. A power factor correction circuit comprising N groups of the power factor correction circuit described in claim 1 and connected in parallel to each other, wherein N=1, 2, 3, . . . .

9. The power factor correction circuit according to claim 8, wherein ON-timings of the switching devices in the N groups of the power factor correction circuits are displaced by T/N, wherein T is an ON-period of the switching devices.

10. The power factor correction circuit according to claim 8, wherein the second rectifying bridge circuit and/or the smoothing capacitor is disposed commonly for the N groups of the power factor correction circuit.

11. A circuit comprising:
a first bridge circuit including at least a switching device and a rectifying device connected in series;
a second bridge circuit including a plurality of diodes connected in series;
a first inductor connected between a first input of the first bridge circuit and a first input of the second bridge circuit; and
a second inductor connected between a second input of the first bridge circuit and a second input of the second bridge circuit.

12. The circuit of claim 11, further comprising a filter capacitor for connection to an AC input, a first terminal of the filter capacitor connected to the first input of the second bridge circuit, and a second terminal of the filter capacitor connected to the second input of the second bridge circuit.

13. The circuit of claim 11, further comprising a smoothing capacitor connected in parallel to an output of the first bridge circuit.

14. The circuit of claim 11, further comprising an overcurrent detector.

15. The circuit of claim 14, further comprising a control circuit to suppress an overcurrent detected by the overcurrent detector.

16. A circuit comprising:
a first bridge circuit including at least a switching device and a rectifying device connected in series;
a second bridge circuit including a plurality of diodes connected in series; and
an inductor including first and second windings wound around a core so as to be magnetically coupled;
wherein
a first terminal of the first winding is connected to a first input of the second bridge circuit, and a second terminal of the first winding is connected to a first input of the first bridge circuit;
a first terminal of the second winding is connected to a second input of the second bridge circuit, and a second terminal of the second winding is connected to a second input of the first bridge circuit, and
a direction of a magnetic flux generated by a current flowing from the first terminal of the first winding to the second terminal of the first winding is opposite to a direction of a magnetic flux generated by a current flowing from the second terminal of the second winding to the first terminal of the second winding.

17. The circuit of claim 16, further comprising a filter capacitor for connection to an AC input, a first terminal of the filter capacitor connected to the first input of the second bridge circuit, and a second terminal of the filter capacitor connected to the second input of the second bridge circuit.

18. The circuit of claim 16, further comprising a smoothing capacitor connected in parallel to an output of the first bridge circuit.

19. The circuit of claim 16, further comprising an overcurrent detector.

20. The circuit of claim 19, further comprising a control circuit to suppress an overcurrent detected by the overcurrent detector.
